(19) United States
(12) Patent Application Publication
(10) Pub. No.: US 2021/0142290 A1
(43) Pub. Date: May 13, 2021

(54) SAFETY TRAINING AND VERIFICATION SOFTWARE

(71) Applicant: Victoria Chacon, Norcross, GA (US)

(72) Inventor: Victoria Chacon, Norcross, GA (US)

(21) Appl. No.: 17/147,443

(22) Filed: Jan. 12, 2021

Related U.S. Application Data
(60) Provisional application No. 62/934,506, filed on Nov. 12, 2019.

(51) Int. Cl. G06Q 10/10; G06Q 10/06

(52) U.S. Cl. CPC G06Q 10/105; G06Q 10/06398; G06Q 10/06311

(57) ABSTRACT

Implementations of a safety training and verification software are provided. In some implementations, the safety training and verification software comprises a mobile application for a portable computing device, such as a mobile phone. In some implementations, the safety training and verification software comprises a software application for a desktop computing device, such as a desktop computer.

In some implementations, a method for the safety training and verification software comprises receiving employee information for safety training and/or certification, submitting the employee information for processing and/or storing, receiving training materials for employee safety training and/or certification, administering the training materials to an employee for safety training and/or certification, and making a record of proof of the employee safety training and/or certification.

### CROSS REFERENCE TO RELATED APPLICATION

This application claims the benefit of U.S. Patent Application Ser. No. 62/934,506, which was filed on Nov. 12, 2019, and is incorporated herein by reference in its entirety.

### TECHNICAL FIELD

This disclosure relates to implementations of a safety training and verification software.

### BACKGROUND

The Occupational Safety and Health Administration (OSHA) was created by Congress to assure safe and healthful working conditions for working men and women by setting and enforcing standards and by providing training, outreach, education, and assistance. The Occupational Safety and Health (OSH) Act covers most private sector employers and their workers, in addition to some public sector employers and workers in the 50 states and certain territories and jurisdictions under federal authority.

Many OSHA standards require that employers train employees to work safely and to recognize and avoid hazards. Also, such safety training must be provided in a language that employees understand. Furthermore, whenever an accident occurs on the job, OSHA investigates and the employer or contractor has to prove that the employee or contractor received the safety training and the dates of the training.

However, there is presently no efficient way (i.e., using a portable computing device, such as a mobile phone, or a desktop computing device, such as a desktop computer) to provide such safety training or such proof of the training. Also, there is presently no such way to provide related reminders or images for such training or other OSHA rules.

### BRIEF DESCRIPTION OF THE DRAWINGS

FIG. 1 illustrates an implementation of an example environment of a safety training and verification software according to the present disclosure.

FIG. 2 illustrates an example computer system, which may be used with implementations of the present disclosure.

FIG. 3 illustrates an implementation of an example method for the safety training and verification software in the environment of FIG. 1 according to the present disclosure.

FIGS. 4A-4K illustrate implementations of example user interfaces of the safety training and verification software according to the present disclosure.

FIGS. 5A-5T illustrate other implementations of example user interfaces of the safety training and verification software according to the present disclosure.

### DETAILED DESCRIPTION

Implementations of a safety training and verification software are provided. In some implementations, the safety training and verification software comprises a mobile application for a portable computing device, such as a mobile phone (or “smart phone”) or similar device (e.g., an iPhone® or iPad®). In some implementations, the safety training and verification software comprises a software application for a desktop computing device, such as a desktop computer. Therefore, the safety training and verification software may be described or otherwise referred to collectively herein the present disclosure as an “application” or “software” for a “computing device”.

In some implementations, the safety training and verification software is configured to efficiently provide Occupational Safety and Health Administration (OSHA) required safety training to employees or workers by using a computing device (e.g., a portable computing device, such as a smart phone or similar device, or a desktop computing device, such as a desktop computer). In some implementations, employees or workers may include regular employees, contractors, and/or any other suitable workers.

In some implementations, the safety training and verification software is configured to provide the training in a language that employees understand. For example, in some implementations, the safety training and verification software is configured to provide the training in one or more suitable languages to allow the employees to understand the training.

In some implementations, the safety training and verification software is configured to offer the required safety training to employees online (e.g., via internet, intranet, or other suitable network).

In some implementations, the safety training and verification software is configured to ensure that workers know mandatory OSHA rules. For example, in some implementations, the safety training and verification software is configured to allow such rules to be communicated to employees by a computing device, such as a smart phone or similar device or a desktop computer.

In some implementations, the safety training and verification software is configured to translate such OSHA rules (e.g., to one or more languages understood by the employees).

In some implementations, the safety training and verification software is configured to test employees on rules, such as basic OSHA mandatory rules.

In some implementations, the safety training and verification software is configured to offer test staff to employees online (e.g., via internet, intranet, or other suitable network). In some implementations, the safety training and verification software is configured to offer testing to employees online.

In some implementations, the safety training and verification software is configured to efficiently (i.e., using a computing device) provide proof that an employee has received the OSHA required safety training and the dates of the training. For example, in some implementations, the safety training and verification software is configured to provide such proof of the employee training and the dates to use for an OSHA investigation of an on the job accident.

In some implementations, the safety training and verification software is configured to keep records of the safety training that workers receive using the safety training and verification software and of the dates the workers received the training.

In some implementations, the safety training and verification software is configured to easily provide certification that a worker has passed required safety courses. For example, in some implementations, the safety training and verification software is configured to quickly provide proof that a worker is safety trained (i.e., certified) and to provide proof of the training received and the dates the worker received the training.

In some implementations, the safety training and verification software is configured to provide reporting of the worker safety training records, such as of the training, training dates, and certification. For example, in some implementations, the safety training and verification software is configured to provide periodic (e.g., monthly) reports of the training records to an employer.

In some implementations, the safety training and verification software is configured to efficiently (i.e., using a computing device) provide reminders related to the OSHA required safety training and/or OSHA rules. For example, in some implementations, the safety training and verification software is configured to be set to provide OSHA related safety reminders to employees.

In some implementations, the safety training and verification software is configured to be set to provide safety reminders at a certain frequency or time interval, such as daily.

In some implementations, the safety training and verification software is configured to be set to provide safety reminders of a certain type or subject, such as mandatory rules (e.g., to remember to wear a hard hat at all times while on a worksite).

In some implementations, the safety training and verification software is configured to be set to provide safety reminders based on any other suitable criteria.

In some implementations, the safety training and verification software is configured to efficiently (i.e., using a computing device) provide images related to the OSHA required safety training and/or OSHA rules. For example, in some implementations, the safety training and verification software is configured to provide images related to training for safety on a worksite. In some implementations, the safety training and verification software may be configured to provide images related to any other suitable safety training and/or rules.

In some implementations, the safety training and verification software is configured, such as described above, such that use of the safety training and verification software will effectively reduce on the job accidents related to OSHA required safety training and/or OSHA rules.

FIG. 3 illustrates an implementation of an example method 300 for the safety training and verification software in the environment of FIG. 1 (described below) according to the present disclosure. In some implementations, with respect to the method 300, a typical job may have a general contractor and one or more subcontractors, wherein each subcontractor may have one or more employees. In some implementations, any other suitable employer-employee configuration may be applicable with respect to the method 300.

In some implementations, the method 300 comprises receiving 302 employee information. In some implementations, receiving 302 employee information comprises each subcontractor (or other employer) entering a name, cell phone number, and email address of each employee that will use the safety training and verification software.

In some implementations, the employee information is received (e.g., entered) using the safety training and verification software on a portable computing device 110a, such as a smart phone or similar device, or on a desktop computing device 110b, such as a desktop computer, (collectively “computing device 110” or “client 110”, described below for FIG. 1). In some implementations, the employee information is received through a user interface of the safety training and verification software on the computing device 110.

In some implementations, the method 300 comprises the safety training and verification software submitting 304 the received employee information from the computing device 110 to a safety training and verification software server, such as the server 130 described below for FIG. 1. In some implementations, the safety training and verification software submits the employee information by transmitting or uploading the entered information from the computing device 110 to the safety training and verification software server 130.

In some implementations, the submitted employee information may be processed by the safety training and verification software server 130. In some implementations, the submitted employee information may be stored in a database 130a (described below for FIG. 1) of the server 130.

In some implementations, the method 300 comprises the safety training and verification software receiving 306 OSHA required safety training information (e.g., training course material) to an employee computing device 110 from the safety training and verification software server 130. In some implementations, the safety training information comprises information that allows an employee to be trained, tested, and certified for OSHA required safety training using the safety training and verification software on the computing device 110.

In some implementations, the method 300 comprises the safety training and verification software administering 308 the received safety training information to an employee on the computing device 110. In some implementations, administering 308 the safety training information comprises training, testing, and/or otherwise certifying the employee for OSHA required safety training. In some implementations, the safety training information is administered through a user interface of the safety training and verification software on the computing device 110.

In some implementations, the method 300 comprises the safety training and verification software recording 310 (i.e., creating or making a record of) the training, testing, and/or certifying (collectively “certification”) of the employee for OSHA required safety training. In some implementations, such recording 310 comprises creating an OSHA approved record of proof of the certification of the employee, such as for an OSHA investigation of an on the job accident.

In some implementations, the record of proof of certification comprises a listing of the completed safety training, the dates of such training, and confirmation of certification for the training, such as by the employee completing the testing and/or other requirements for the training. In some implementations, the record of proof of certification may comprise any other suitable information required for proof of employee certification for safety training.

In some implementations, the record of proof of certification may be stored on the employee computing device 110, such as for quick and easy availability to prove certification. In some implementations, the record of proof of certification may also (or alternately) be transmitted to the safety training and verification software server 130 and stored in the server database 130a for quick and easy availability to prove certification.

In some implementations, the record of proof of certification for one or more employees may be provided to the employer (e.g., the subcontractor) in a periodic (e.g., monthly) report. For example, in some implementations, the records may be processed into the report by the safety training and verification software server 130. In some implementations, the report may be received from the safety training and verification software server 130 and displayed on a computing device 110 by the safety training and verification software.

In some implementations, the record of proof of certification may be processed and/or stored in any other suitable way to allow for quick and easy availability to prove certification.

FIGS. 4A-4B illustrate an implementation of an example user interface of the safety training and verification software for entering user or employee information to allow use of the safety training and verification software, such as described above.

FIG. 4C illustrates an implementation of an example user interface of the safety training and verification software for selecting a language that allows a user to understand training, testing, etc. provided by the safety training and verification software, such as described above.

FIG. 4D illustrates an implementation of an example user interface of the safety training and verification software for registering (e.g., by a user or employee) to receive safety training using the safety training and verification software, such as described above.

FIG. 4E illustrates an implementation of an example user interface of the safety training and verification software for receiving reminders related to safety training, rules, etc. using the safety training and verification software, such as described above.

FIG. 4F illustrates an implementation of an example user interface of the safety training and verification software for reviewing and/or selecting (e.g., by a user or employee) available and/or completed safety training using the safety training and verification software, such as described above.

FIGS. 4G-4H illustrate implementations of example user interfaces of the safety training and verification software for administering safety training to a user (e.g., with text, images, etc.) by the safety training and verification software, such as described above.

FIGS. 4I-4J illustrate an implementation of an example user interface of the safety training and verification software for administering safety training testing to a user by the safety training and verification software, such as described above.

FIG. 4K illustrates an implementation of an example user interface of the safety training and verification software for providing a record of proof using the safety training and verification software of a user's safety training certification, such as described above.

FIG. 5A illustrates an implementation of an example user interface of the safety training and verification software for allowing a user to select various features of the safety training certification and verification software, such as training, testing, and proof of certification as described above.

FIGS. 5B-5C illustrate an implementation of an example user interface of the safety training and verification software for administrator registration (such as by a user or employer) for use of the safety training and verification software, such as described above.

FIGS. 5D-5E illustrate implementations of example user interfaces of the safety training and verification software for managing payment credits for using the safety training and verification software.

FIGS. 5F-5I illustrate implementations of example user interfaces of the safety training and verification software for administrating and reviewing the use of the safety training and verification software, such as for an employer to administrate and review use of the software by employees as described above.

FIGS. 5J-5K illustrate other implementations of example user interfaces of the safety training and verification software for registering to receive safety training using the safety training and verification software, such as described above.

FIG. 5L illustrates another implementation of an example user interface of the safety training and verification software for reviewing and/or selecting available and/or completed safety training using the safety training and verification software, such as described above.

FIGS. 5M-50 illustrate other implementations of an example user interface of the safety training and verification software for administering safety training testing to a user by the safety training and verification software, such as described above.

FIGS. 5P-5S illustrate other implementations of example user interfaces of the safety training and verification software for providing a record of proof of a user's safety training certification using the safety training and verification software, such as described above.

FIG. 5T illustrates another implementation of an example user interface of the safety training and verification software for receiving reminders related to safety training, rules, etc. using the safety training and verification software, such as described above.

FIG. 1 illustrates an implementation of an example environment of a safety training and verification software 100 according to the present disclosure.

As shown in FIG. 1, in some implementations, the environment 100 may include one or more client devices 110a and 110b (collectively “client devices 110”), wireless cellular network 120, network 125, and safety training and verification software (“STVS”) servers 130. In some implementations, the environment 100 may also include one or more data storages 130a linked to the servers 130.

As described above, in some implementations, a computing device (“client device”) 110 may be used to receive employee information from an employer or user of the safety training and verification software. In some implementations, the client device 110 may be used to display a user interface for receiving the employee information from the safety training and verification software user.

As described above, in some implementations, the client device 110 may be used to submit the received employee information to an STVS server 130. In some implementations, the client device 110 may be used to transmit or upload the entered information to the STVS server 130.

As described above, in some implementations, the submitted employee information may be processed by the STVS server 130. In some implementations, the submitted employee information may be stored in a database 130a of the STVS server 130.

As described above, in some implementations, the client device 110 may be used to receive OSHA required safety training information from the STVS server 130. As described above, in some implementations, the client device 110 may be used to administer the received safety training information to an employee or user of the safety training and verification software. In some implementations, the client device 110 may be used to display a user interface for administering the received safety training information to the safety training and verification software user.

As described above, in some implementations, the client device 110 may be used to make a record of proof of the required training, testing, and/or certifying (collectively “certification”) received by an employee or user of the safety training and verification software. In some implementations, the client device 110 may be used to store the record of proof of certification for quick and easy availability to prove certification of a safety training and verification software user.

As described above, in some implementations, the client device 110 may be used to transmit the record of proof of certification to the STVS server 130 for storage in the server database 130a for quick and easy availability to prove certification of a safety training and verification software user. In some implementations, the transmitted record of proof of certification may be processed by the STVS server 130 to provide a periodic (e.g., monthly) report of the certification activity provided to users by the safety training and verification software.

As described above, in some implementations, the client device 110 may be used to receive the periodic certification report from the STVS server 130 and to display the report. In some implementations, the client device 110 may be used to display a user interface for displaying the periodic certification report provided by the safety training and verification software.

Client devices 110a and 110b (collectively “client devices 110”) are depicted as a mobile phone 110a and a desktop computer 110b, respectively, but client devices 110 may comprise any type of computing device, such as a desktop computer system, a laptop, cellular phone, a smart device, a mobile telephone, a tablet-style computer, or any other device capable of wireless or wired communication. In some implementations, client devices 110 are configured to interact with the server 130 via an application, such as a web browser or a native application, residing on the client device 110.

In some implementations, the client devices 110 include hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the environment 100 or any other component suitable for a particular purpose.

In some implementations, the client devices 110 are configured to access networks 120 and/or 125. In some implementations, the client devices 110 are configured to communicate with servers 130.

In some implementations, the client devices 110 can connect to the network 125 through a wireless cellular network 120, such as GPRS-based and CDMA-based wireless networks, as well as 802.16 WiMax and long-range wireless data networks.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130 may include a processor, memory, user accounts, and one or more modules to perform various functions such as those described above.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, one or more data storages 130a may be communicatively linked to one or more servers 130, respectively, via one or more links 150. In some implementations, data storages 130a may be used to store various types of information. In some implementations, the information stored in data storages 130a may be organized according to specific data structures. In particular embodiment, each data storage 130a may be a relational database. Particular embodiments may provide interfaces that enable servers 130 or clients 110 to manage, e.g., retrieve, modify, add, or delete, the information stored in data storage 130a.

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the safety training and verification software.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A non-transitory computer readable medium containing instructions that, when executed by a processor on a computing device, cause the computing device to:
display on the computing device occupational safety training material;
receive responses to the occupational safety training material from an input device;
store an indication based on the responses to the occupational safety training material from the input device; and
displaying the indication in response to a request from the input device.

2. The non-transitory computer readable medium of claim 1 wherein the instructions, when executed by a processor on a computing device, further causes the computing device to display on the computing device the occupational safety training material in a language other than English.

3. The non-transitory computer readable medium of claim 1 wherein the computing device is a smart phone.

4. The non-transitory computer readable medium of claim 1 wherein the instructions, when executed by a processor on a computing device, further causes the computing device to display daily on the computing device one or more mandatory Occupational Safety and Health Administration (OSHA) rules as a reminder during the duration of a job.

5. The non-transitory computer readable medium of claim 1 wherein the indication based on the responses to the occupational safety training material from the input device comprises an indication of a worker completing the occupational safety training material displayed on the computing device.

6. The non-transitory computer readable medium of claim 1 wherein the indication based on the responses to the occupational safety training material from the input device comprises an indication of a worker passing the occupational safety training material displayed on the computing device.

7. A method for safety training and verification using the non-transitory computer readable medium of claim 1, the method comprising:
receiving over a network and executing on a first computing device the instructions;
receiving at the first computing device over a network occupational safety training material;
displaying on the first computing device the occupational safety training material to a worker;
storing an indication based on the responses to the occupational safety training material from the worker from an input device; and
displaying the indication as a pre-condition for working on a job.

8. A non-transitory computer readable medium containing instructions that, when executed by a processor on a first computing device, cause the first computing device to:
receive from a second computing device over a network information uniquely identifying a worker;
transmit to the second computing device over a network occupational safety training material;
store status information regarding the worker with respect to the occupational safety training material; and
transmit to a computer device over a network the status information upon receiving a request.

9. The non-transitory computer readable medium of claim 8 wherein the information uniquely identifying a worker comprises the name and contact information of the worker.

10. The non-transitory computer readable medium of claim 8 wherein the status information regarding the worker comprises an indication of the worker completing the occupational safety training material.

11. The non-transitory computer readable medium of claim 8 wherein the status information regarding the worker comprises an indication of the worker passing the occupational safety training material.

12. The non-transitory computer readable medium of claim 8 wherein the status information regarding the worker comprises a date of the worker completing certification requirements of the occupational safety training material.

13. A method for verification using the non-transitory computer readable medium of claim 8, the method comprising:
receiving at a computer device over a network status information regarding a worker with respect to occupational safety training material; and
making a determination of eligibility to work based on the status information.

14. The method of claim 13 wherein the status information regarding the worker comprises an indication of the worker completing certification requirements of the occupational safety training material.

15. The method of claim 13 wherein the status information regarding the worker comprises a date of the worker completing certification requirements of the occupational safety training material.

16. A non-transitory computer readable medium containing instructions that, when executed by a processor on a computing device, cause the computing device to:
display on the computing device occupational safety training material;
receive responses to the occupational safety training material from an input device;
store an indication based on the responses to the occupational safety training material from the input device;
display the indication in response to a request from the input device; and
display daily on the computing device one or more Occupational Safety and Health Administration (OSHA) rules as a reminder during the duration of a job;
wherein the computing device is a smart phone.

17. The non-transitory computer readable medium of claim 16 wherein the indication based on the responses to the occupational safety training material from the input device comprises an indication of a worker completing the occupational safety training material displayed on the computing device.

18. The non-transitory computer readable medium of claim 16 wherein the indication based on the responses to the occupational safety training material from the input device comprises an indication of a worker passing the occupational safety training material displayed on the computing device.

19. A computer-implemented method for safety training and verification, the method comprising:
receiving information of an employee for occupational safety training and certification of the employee;
receiving training materials for the occupational safety training and certification;
administering the training materials to the employee for the occupational safety training and certification of the employee; and
making a record of proof of the administering of the training materials to the employee.

20. The computer-implemented method of claim 19 further comprising providing a reminder related to the training materials.
